(19) United States
(12) Patent Application Publication
(10) Pub. No.: US 2019/0075343 A1
(43) Pub. Date: Mar. 7, 2019

(54) SYSTEM AND METHOD FOR LIVE VIDEO PRODUCTION MONITORING AND ANNOTATION

(71) Applicant: Zullavision, Inc., Hollywood, CA (US)

(72) Inventors: Aviram COHEN, Gealya (IL); Charles Booey KOBER, Los Angeles, CA (US); Eytan KELLER, Los Angeles, CA (US); Yoav NISSAN-COHEN, Mishmar David (IL)

(73) Assignee: Zullavision, Inc., Hollywood, CA (US)

(21) Appl. No.: 15/922,008

(22) Filed: Mar. 15, 2018

Related U.S. Application Data
(60) Provisional application No. 62/553,369, filed on Sep. 1, 2017.

(51) Int. Cl. H04N 21/242; H04N 21/431; H04N 21/2187; G06F 17/24

(52) U.S. Cl. CPC H04N 21/242; G06F 17/241; H04N 21/2187; H04N 21/4316

(57) ABSTRACT

An interactive live video production monitoring and control system contains a base station, connected to audio and video sources, that transmits live audio and video to an interactive mobile tablet using low-latency wireless communication. The mobile tablet displays the audio and video feeds of single or multiple audio and video sources with imperceptible delay. It allows users in the production team to roam freely throughout the production environment, while interacting directly with other users in the production environment and or remotely with other off-site members of the team. Users can interact with each other while viewing, recording and annotating the video feeds. The mobile tablet incorporates an ultra-low-latency wireless link. The mobile tablet allows users to view, record and playback live audio and video from one or multiple audio and video sources. Users can instantly annotate the live video and textual documents, as well as view and annotate the recorded video. All of the annotations and textural documents are always in sync with the recorded content. The system enables audio, video and metadata collaboration between users on the production site and off-site users, anywhere in the world.

### PRIORITY CLAIM

The present application claims priority to U.S. Provisional Patent Application No. 62/553,369, entitled “System and Method for Live Video Production Monitoring and Annotation,” filed Sep. 1, 2017, the entirety of which is hereby incorporated by reference.

### TECHNICAL FIELD

The present invention relates generally to the field of video monitoring and recording, and, as an example, to the live monitoring of a video production such as television, film or an event.

### BACKGROUND

The director of a television or film video production has a difficult, complex, multi-faceted task. The director may manage hundreds of people including actors, camera crew, stage crew, lighting crew, sound crew. During shooting, the director wants to capture the best possible video using multiple video and film cameras and other video and imagery sources that provide different angles and have different lenses that enable multiple fields of view. After shooting, the director will edit the video captured by the cameras and the other sources of imagery to create a high-quality production.

Today's directors, as well as other members of the creative team, find it difficult to monitor live the cameras and other sources of imagery and also watch the recorded content while they freely move around the production set interacting with actors and crew.

Any means for both reducing the shooting time and increasing efficiency by allowing all members of the creative team to more easily monitor the live cameras and the recorded content either together or separately will significantly benefit the production.

### BRIEF DESCRIPTION OF THE DRAWINGS

The drawings are made to point out and distinguish the invention from the prior art. The objects, features and advantages of the invention are detailed in the description taken together with the drawings.

FIG. 1 is an exemplary diagram showing an embodiment of a system for live video production monitoring and annotation.

FIG. 2 is an exemplary diagram showing an embodiment of the SHOTGLASS™ mobile tablet.

FIG. 3a is an exemplary picture showing the front-view of an embodiment of the SHOTGLASS™ mobile tablet.

FIG. 3b is an exemplary picture showing the rear-view of an embodiment of the SHOTGLASS™ mobile tablet.

FIG. 4 is an exemplary flow chart showing a process for monitoring and annotating live video in the SHOTGLASS™ system.

FIG. 5 shows exemplary screenshots of a SHOTGLASS™ mobile platform.

### DETAILED DESCRIPTION

The SHOTGLASS™ system provides interactive, live video production monitoring and control. The SHOTGLASS™ system contains a SHOTGLASS™ base station, connected to audio and video sources, that transmits live audio and video to one or more SHOTGLASS™ mobile tablets using ultra-low-latency wireless communication. The SHOTGLASS™ mobile tablet displays the audio and video feeds of a single or multiple audio and video sources with imperceptible delay. The SHOTGLASS™ mobile tablet allows users in the production team to roam freely throughout the production environment, while interacting directly with other users in the production environment and or remotely with other off-site members of the team. Users can interact with each other while viewing, recording and annotating the video feeds. The SHOTGLASS™ mobile tablet incorporates an ultra-low-latency wireless link allowing SHOTGLASS™ mobile tablet users to experience a worst-case latency of 7 video frames and in some cases only a one video frame latency. The SHOTGLASS™ mobile tablet allows users to view, record and playback live audio and video from one or multiple audio and video sources. Users can instantly annotate the live video and any textual documents, as well as playback and annotate the recorded audio and video. The system enables audio, video and metadata collaboration between users on the production site and off-site users, anywhere in the world.

SHOTGLASS™ is a registered trademark of Zullavision. Although the specification refers to the SHOTGLASS™ system and SHOTGLASS™ components, it will be appreciated that the invention is not limited to the SHOTGLASS™ system and SHOTGLASS™ components and that they are merely exemplary. Embodiments of the invention include non- SHOTGLASS™ systems and components as will be appreciated by persons of skill in the art.

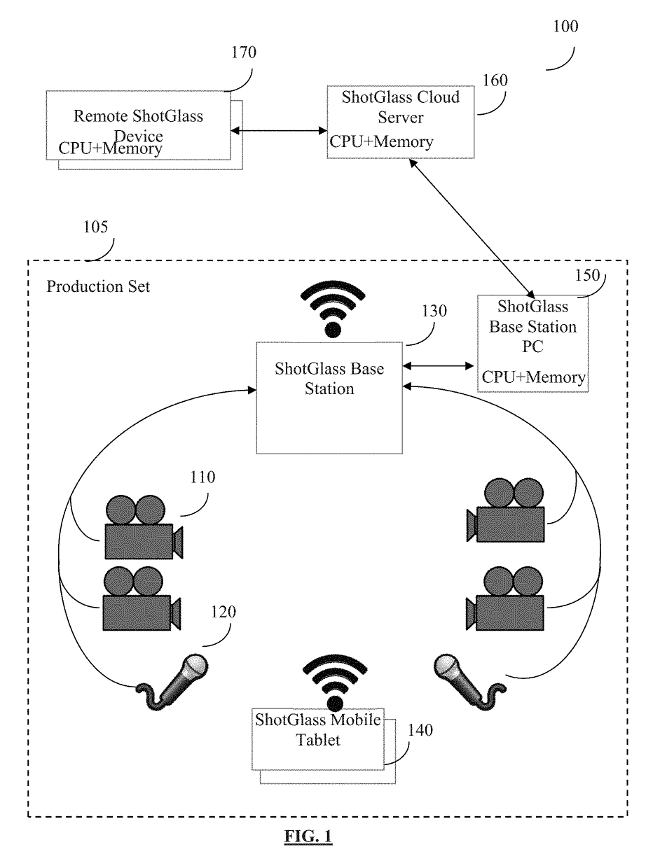

FIG. 1 is an exemplary diagram 100 showing an embodiment of the SHOTGLASS™ system. FIG. 1 illustrates an exemplary production set 105. In FIG. 1, the production set 105 includes one or more video cameras 110, one or more microphones 120, a SHOTGLASS™ base station 130, one of more SHOTGLASS™ mobile tablets 140 and a SHOTGLASS™ base station PC 150. In this example embodiment, the SHOTGLASS™ base station PC 150 communicates with a remote SHOTGLASS™ cloud server 160. The SHOTGLASS™ base station PC 150 also communicates with the SHOTGLASS™ base station 130. Remote users interact with a remote SHOTGLASS™ device 170 that communicates with the remote SHOTGLASS™ cloud server 160.

The video camera 110 records high-quality video, called the master copy, which is stored locally at the camera, by the camera itself or by an external storage device. The video camera 110 sends a live copy of the video to the SHOTGLASS™ base station 130. In addition to supporting video cameras, the SHOTGLASS™ system supports other types of video sources including, but not limited to, tape storage units and teleprompters. The SHOTGLASS™ system supports multiple types of video cameras with different video parameters including resolution, frame rate, video format and video bit depth. In one configuration, the video camera 110 records 60 frames per second, with 1080P resolution, 8-bit RGB data. In the example of FIG. 1, the video camera 100 has a wired connection to the SHOTGLASS™ base station 130. In a second embodiment, the video camera 100 communicates wirelessly to the SHOTGLASS™ base station 130.

In one configuration, the SHOTGLASS™ base station 130 combines the individual video camera feeds to create a single composite video feed. For example, the SHOTGLASS™ base station 130 may receive four 1080P video feeds from four different video cameras and produce a single 1080P video feed with 4 quadrants. Each quadrant shows the video from one of the four video cameras at reduced resolution. In a second configuration, the SHOTGLASS™ base station 130 sends the full resolution video camera feed from a specified video camera.

The microphone 120 records sound and sends the live sound recording to the SHOTGLASS™ base station 130 over a wired or wireless communication channel. The SHOTGLASS™ base station 130 receives live video from the video cameras 110 and audio sound from microphones 120.

The SHOTGLASS™ base station 130 transmits synced video and audio to the SHOTGLASS™ mobile tablets 140 with negligible delay. The SHOTGLASS™ base station 130 is configured to send either high-quality, full-resolution video or lower-quality proxy video to the SHOTGLASS™ mobile tablets 140. The SHOTGLASS™ base station 130 also has the option to send lower-quality video, called proxy video, to other devices in the network. In one embodiment, the SHOTGLASS™ base station 130 sends lower-quality, compressed video to the remote SHOTGLASS™ cloud server 160, which is then accessed by remote users using remote SHOTGLASS™ device 170.

In some embodiments, the SHOTGLASS™ base station 130 transmits audio and video containing an embedded time-code. The time-code defines the recording time and, together with video camera or microphone identifier, uniquely identifies the video and audio on a frame by frame basis. The video time-codes are generated by the video cameras, by a time-code generator or generated internally by the tablet, so that the time-codes captured by the SHOTGLASS™ system are the same time-codes which are embedded in the master copies of the recorded content. If multiple video cameras generate time-codes, the video cameras are synchronized so that each video camera generates the same time-code for the same interval. In another embodiment, a time-code synchronization device is attached to each video camera. Similarly, the audio time-codes are generated by a time-code generator or generated internally by the tablet and synchronized to match the video time-codes. The SHOTGLASS™ mobile tablet has an option to visually display the time-code, as an overlay on the content being recorded on the tablet. In one embodiment, the tablet will not record any content unless it's synchronized to either an external source of time-code or the tablet's internal clock.

The SHOTGLASS™ base station 130 contains an ultra-low latency chipset for wireless communication such as that developed and sold by the company Amimon. The Amimon chipset utilizes Joint-Source-Channel-Coding (JSCC) algorithms developed specifically to enable zero delay delivery of high-definition and ultra-high-definition video. When the SHOTGLASS™ base station 130 sends the full resolution video camera feed (from a single video camera) the SHOTGLASS™ mobile tablet user will typically experience a one video frame delay. When the SHOTGLASS™ base station 130 generates and sends a composite feed the SHOTGLASS™ mobile tablet user will experience a longer latency. Decimating and compositing the video introduces additional latency.

In one embodiment, the SHOTGLASS™ base station 130 contains a video capture card and logic implemented in a FPGA or integrated circuit. In this embodiment, the SHOTGLASS™ base station 130 may also contain memory. In a second embodiment, the SHOTGLASS™ base station 130 also includes a CPU, memory and storage. The CPU may include processors, microprocessors, microcontrollers, digital signal processors (DSPs), field-programmable gate arrays (FPGAs), analog and/or digital application-specific integrated circuits (ASICs), or the like, or combinations thereof. The CPU may generally execute, process, or run instructions, code, code segments, software, firmware, programs, applications, apps, processes, services, daemons, or the like, or may step through states of a finite-state machine, or combinations of these actions. The CPU may be in communication with the other electronic components through serial or parallel links that include address busses, data busses, control lines, and the like. In some configurations, the CPU may consist of a single microprocessor or microcontroller. However, in other configurations, the CPU may comprise a plurality of processing devices (e.g., microprocessors, DSPs, etc.). The memory and storage may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage may include, or may constitute, a “computer-readable medium”. The storage may store the instructions, code, code segments, software, firmware, programs, applications, apps, services, daemons, or the like that are executed by the CPU. The storage may also store settings, data, documents, sound files, photographs, movies, images, databases, and the like.

In an alternate embodiment to that shown in FIG. 1, the SHOTGLASS™ base station 130 may be adapted to perform the functions of the SHOTGLASS™ base station PC 150 (i.e., the base station PC 150 is not required in the alternate embodiment).

The SHOTGLASS™ mobile tablet 140 receives live video and audio from the SHOTGLASS™ base station 130 over a special, low-latency wireless connection. This allows users to be able to monitor the live video sources on the SHOTGLASS™ mobile tablet 140 without a noticeable delay between what the users are seeing live and the view they see on the SHOTGLASS™ mobile tablet 140.

In normal operation, the SHOTGLASS™ mobile tablet 140 displays live and recorded video on its display screen. Users can decide if they want to hear the audio, either live or in playback mode. Users can select to hear multiple audio sources that are synced to the live and recorded video. These sources can be heard all together or listened to in various configurations, as selected by the user.

The SHOTGLASS™ mobile tablet 140 has controls for selecting which single video source, in a multi-view configuration to view full screen. For example, double tapping the desired single video source that appears in a multi-view configuration causes the SHOTGLASS™ mobile tablet 140 to switch to the indicated single video source and display it full screen. In one configuration, the SHOTGLASS™ base station 130 accepts a command from the SHOTGLASS™ mobile tablet 140 causing the SHOTGLASS™ base station 130 to change the transmitted video feed. In a second configuration, the SHOTGLASS™ mobile tablet 140 changes its display by itself splitting the incoming video stream into its component video camera feeds and selecting the appropriate component video camera feed.

The SHOTGLASS™ mobile tablet 140 has controls for starting and stopping recording. While recording is active, the SHOTGLASS™ mobile tablet 140 stores audio and video to its local storage. At any point in time, either while recording or at any time after, a user can access playback of recorded video and audio. Having local storage allows a SHOTGLASS™ mobile tablet user to playback audio and video regardless of the availability of wireless connectivity.

The SHOTGLASS™ mobile tablet 140 has an option to synchronize recordings with other SHOTGLASS™ mobile tablets 140. If a first SHOTGLASS™ mobile tablet user starts recording before a second SHOTGLASS™ mobile tablet is powered on (or if the second SHOTGLASS™ tablet is outside of the wireless reception area), the second SHOTGLASS™ mobile tablet will request the recorded data from the first SHOTGLASS™ mobile tablet or from the SHOTGLASS™ base station. In some embodiments, the SHOTGLASS™ mobile tablets 140 communicate with each other using WiFi connections. It will be appreciated that other communication methods may be used to connect the SHOTGLASS™ mobile tablets 140.

The SHOTGLASS™ mobile tablet 140 has controls for annotating the video. The users typically define a number of different things, including but not limited to: a) which video sequences should be included in the final production; b) which video sequences should be excluded from the final production; c) which video sequences should be used for a promotional trailer; and/or d) which video sequence needs artwork or special effects to be added. Users select video marker icons displayed on the SHOTGLASS™ mobile tablet to label different types of video sequences. Each user can annotate video with one or more markers as well as adding textual comments. When a user annotates the video with a marker, the SHOTGLASS™ mobile tablet 140 generates and displays a low-resolution, still image generated from the first frame of the selected video. Users can add free-hand, graphical annotation by telestrating over the still images in multiple colors. The low-resolution, still image is shown on a time-line. The SHOTGLASS™ mobile tablet 140 has some pre-defined marker types and allows users to define new types of marker. Users can categorize the different marker types in different ways, such as, for example, by department. Users can annotate the video with markers under multiple scenarios including: a) annotating live video as the video is being recorded; b) playing back recorded video and annotating it; and c) during live recording, starting playback of recorded video, annotating the playback video, and then returning to viewing the live video. The information defined by the different marker types is known as metadata. The time-code identifies the location of the metadata on the video sequence. Different users can independently annotate the video. The SHOTGLASS™ mobile tablet 140 automatically shares and synchronizes metadata between different SHOTGLASS™ mobile tablets and with the remote SHOTGLASS™ cloud server 160.

In some embodiments, the SHOTGLASS™ mobile tablet 140 displays different categories of low-resolution, still images that correspond to user-defined marker locations. If a user clicks on a low-resolution still image, the SHOTGLASS™ mobile tablet plays back the corresponding video and audio, as well as identifying the camera, microphone, take number and time-code. Users may generate an email from the SHOTGLASS™ mobile tablet 140 that references one or more markers directly from the tablet. The sent document automatically indicates the sender's name, the production name, the scene name, the take number, the date, and the time-code address of the content that relates to this marker and syncs with the recorded content. The email receiver views the appropriate audio and video by selecting a marker embedded in the email.

SHOTGLASS™ mobile tablets 140 communicate with the remote SHOTGLASS™ cloud server 160 using a regular WiFi connection to access the WAN. It will be appreciated that other communication connects can be used for communication between the SHOTGLASS™ mobile tablets 140 and the SHOTGLASS™ cloud server 160.

After the recordings are concluded, the users can review the recordings. Users can add more markers as well as textual and/or graphical notes or comments. All of these become part of the available metadata.

FIG. 1 shows a SHOTGLASS™ base station PC 150 connected to a SHOTGLASS™ base station 130 and communicating over a wide area network (WAN) with a remote SHOTGLASS™ cloud server 160. The SHOTGLASS™ base station PC 150 transmits the audio and video from the SHOTGLASS™ base station 130 to the SHOTGLASS™ cloud server 160. The SHOTGLASS™ base station PC 150 compresses the audio and video before sending it over the WAN. The SHOTGLASS™ base station PC 150 supports multiple, standard, audio and video codecs and transport formats including, for example, H.264 and AC3.

In some embodiments, the SHOTGLASS™ base station PC 150 is a standard personal computer with a single or multi-core CPU, memory and storage. The CPU may include processors, microprocessors, microcontrollers, digital signal processors (DSPs), field-programmable gate arrays (FPGAs), analog and/or digital application-specific integrated circuits (ASICs), or the like, or combinations thereof. The CPU may generally execute, process, or run instructions, code, code segments, software, firmware, programs, applications, apps, processes, services, daemons, or the like, or may step through states of a finite-state machine, or combinations of these actions. The CPU may be in communication with the other electronic components through serial or parallel links that include address busses, data busses, control lines, and the like. In some configurations, the CPU may consist of a single microprocessor or microcontroller. However, in other configurations, the CPU may comprise a plurality of processing devices (e.g., microprocessors, DSPs, etc.). The memory and storage may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage may include, or may constitute, a “computer-readable medium”. The storage may store the instructions, code, code segments, software, firmware, programs, applications, apps, services, daemons, or the like that are executed by the CPU. The storage may also store settings, data, documents, sound files, photographs, movies, images, databases, and the like.

In some embodiments, the SHOTGLASS™ base station PC 150 has a wired connection to a router communicating with the WAN and a wired connection to the SHOTGLASS™ base station 130. In some embodiments, the SHOTGLASS™ base station PC 150 has one or more wireless connections.

The remote SHOTGLASS™ cloud server 160 may be one or more computers or server computers, the computers having one or more processors, memory and storage. The CPU may include processors, microprocessors, microcontrollers, digital signal processors (DSPs), field-programmable gate arrays (FPGAs), analog and/or digital application-specific integrated circuits (ASICs), or the like, or combinations thereof. The CPU may generally execute, process, or run instructions, code, code segments, software, firmware, programs, applications, apps, processes, services, daemons, or the like, or may step through states of a finite-state machine, or combinations of these actions. The CPU may be in communication with the other electronic components through serial or parallel links that include address busses, data busses, control lines, and the like. In some configurations, the CPU may consist of a single microprocessor or microcontroller. However, in other configurations, the CPU may comprise a plurality of processing devices (e.g., microprocessors, DSPs, etc.). The memory and storage may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage may include, or may constitute, a “computer-readable medium”. The storage may store the instructions, code, code segments, software, firmware, programs, applications, apps, services, daemons, or the like that are executed by the CPU. The storage may also store settings, data, documents, sound files, photographs, movies, images, databases, and the like.

The remote SHOTGLASS™ cloud server 160 stores a copy of the compressed audio and video for remote users to access. The remote SHOTGLASS™ cloud server 160 supports multiple production sets and can connect to multiple SHOTGLASS™ base station PCs over a WAN. In one embodiment, there are multiple remote SHOTGLASS™ cloud servers 160 which can be located in different places.

Remote users interact with a remote SHOTGLASS™ device 170 that communicates with the remote SHOTGLASS™ cloud server 160. The remote SHOTGLASS™ device 170 may be a desktop computer, laptop, tablet or other form of computer with one or more processors, memory and storage. In one particular embodiment, the remote SHOTGLASS™ device 170 is a SHOTGLASS™ mobile tablet. Remote users can playback video and audio, review metadata and add their own metadata.

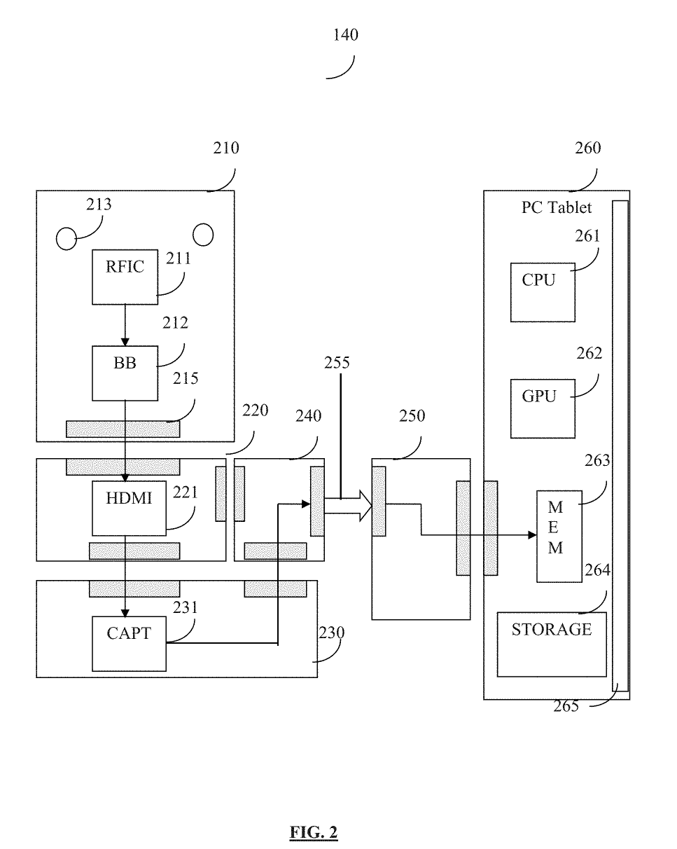

FIG. 2 is an exemplary diagram 140 showing an embodiment of the SHOTGLASS™ mobile tablet. In FIG. 2 the SHOTGLASS™ mobile tablet is implemented using a standard PC tablet 260 augmented with PC boards 210-250. PC boards 210-250 have connectors 215 for connecting the boards together.

PC board (wireless board) 210 receives video and audio from the SHOTGLASS™ base station using a wireless connection. The wireless board 210 contains an ultra-low latency chipset for wireless communication. Wireless board 210 contains a radio-frequency integrated circuit (RFIC) 211 connected to one or more antennas 213. The RFIC 211 drives the baseband integrated circuit (BB) and produces digital audio and video data.

HDMI board 220 converts the data output from wireless board 210 into HDMI format suitable for the standard video capture board 230. The HDMI board 220 may include an HDMI chip 221. A standard HDMI chip 221 may be used. The HDMI chip 221 converts received RGB data into an HDMI format for use by the video capture board 230.

The video capture board 230 captures video on the tablet. The video capture board 230 includes a video capture chip 231. The video capture chip 231 converts the HDMI video data into PCI format.

Height extender board 240 compensates for differences in height between the boards. It will be appreciated that the height extender board 240 is optional and is used as needed as understood by persons of skill in the art.

The Mini PCI Express Adapter board 250 connects to the height extender board 240 using a special, PCI cable 255. The special, PCI cable 255 connects the pins of the height extender board 240 to the pins of the Mini PCI Express Adapter board 250. The special, PCI cable 255 is designed to have appropriate length and to avoid noise on the cable wires. The Mini PCI Express Adapter board 250 plugs into a PCI connector slot on the standard PC tablet 260. The Mini PICI Express Adapter board 250 connects the functionality of PC boards 210-230 to the PC tablet 260.

The PC tablet 260 includes a CPU 261, a graphics processing unit (GPU) 262, memory 263 and storage 264. The video and audio data are sent to the memory 263 of the standard PC tablet 260. The graphics processing unit (GPU) 262 displays the video on the touch-screen 265. The PC tablet 260 may also include a speaker 266 for playing audio. Alternatively, an audio playback device may be connected externally, e.g., as headphones to the PC tablet 260 for playing audio. The CPU 261 executes software instructions contained in storage 264. Storage 264 holds video, audio, text documents, video annotations as well as software.

The memory 263 and storage 264 may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage 264 may include, or may constitute, a “computer-readable medium”. The storage 264 may store the instructions, code, code segments, software, firmware, programs, applications, apps, services, daemons, or the like that are executed by the CPU 261. The storage 264 may also store settings, data, documents, sound files, photographs, movies, images, databases, and the like.

In an alternate embodiment, instead of using the Mini PCI Express Adapter board 250, a USB 3.0 interface may be provided on the standard PC tablet 260.

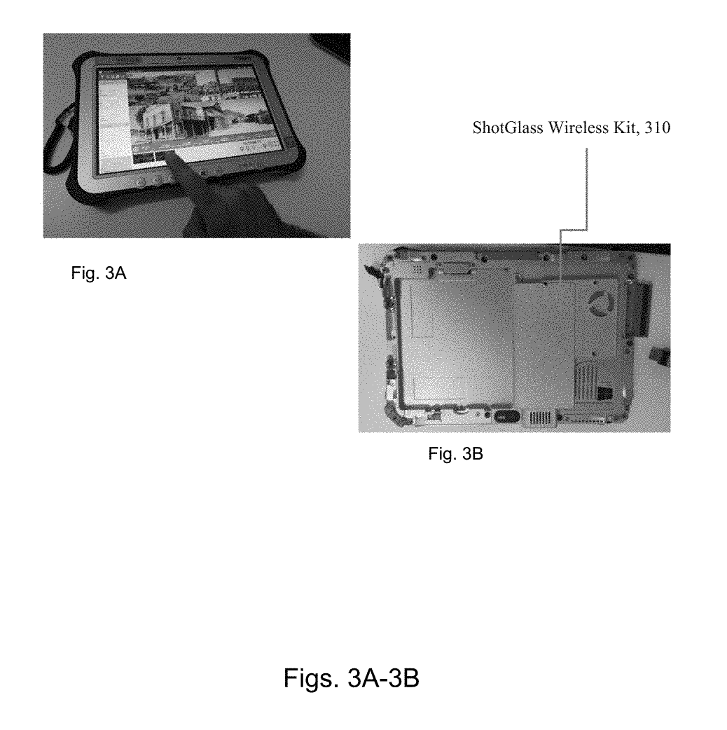

FIG. 3a is an exemplary picture showing the front-view of an embodiment of the SHOTGLASS™ mobile tablet. FIG. 3b is an exemplary picture showing the rear-view of an embodiment of the SHOTGLASS™ mobile tablet. PC boards 210, 220, 230, 240 and 250 of FIG. 2 form wireless kit 310 shown in FIG. 3b.

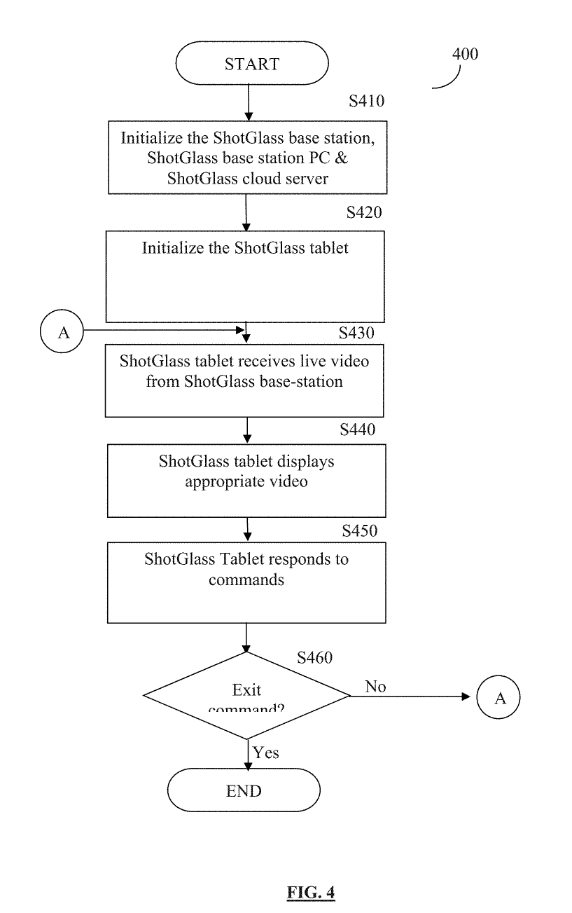

FIG. 4 is an exemplary flow chart showing a process for monitoring and annotating live video in the SHOTGLASS™ system.

The process begins by turning on and initializing the equipment (block S410). The remote SHOTGLASS™ cloud server is normally powered on and supports multiple video productions. The SHOTGLASS™ base station and SHOTGLASS™ base station PC for a specific video production are powered on. An operator logs in to the SHOTGLASS™ base station PC and the SHOTGLASS™ base station PC communicates with remote SHOTGLASS™ cloud server, identifying itself. The SHOTGLASS™ base station establishes a connection with attached audio and video sources, which typically includes microphones and video cameras.

The SHOTGLASS™ mobile tablet is powered on and a user logs in (block S420). The SHOTGLASS™ mobile tablet loads configuration options and allows the user to modify the configuration options. One of the configuration options is to define different types of markers. The SHOTGLASS™ mobile tablet establishes an ultra-low-latency communication link with the SHOTGLASS™ base station.

The SHOTGLASS™ mobile tablet receives live, ultra-low-latency video and audio from the SHOTGLASS™ base station (block S430).

The SHOTGLASS™ mobile tablet displays the video on the SHOTGLASS™ mobile tablet display (block S440).

The SHOTGLASS™ mobile tablet responds to user commands (block S450). User commands include but are not limited to:
Change the display of the video sources
Select audio channels for record and playback
Start or end recording of video “takes”
Add or edit markers.
Playback previously recorded audio and video.
Add or edit textual and/or graphical video annotations.
Import textual documents into the tablet, annotate and edit them
Select browsing options to enable viewing of content from the internet, either side by side with the video and audio content or full screen without the imagery.

The SHOTGLASS™ mobile tablet transmits any newly entered meta-data (e.g, video markers, textual and/or graphical video annotations) to other SHOTGLASS™ mobile tablets and to the SHOTGLASS™ cloud server. The SHOTGLASS™ mobile tablet checks if the entered user command (block S450) is an ‘exit’ command (block S460). If the SHOTGLASS™ mobile tablet detects an ‘exit’ command it logs out the user. If the SHOTGLASS™ mobile tablet detects a different command it loops back to block S430. In some embodiments, the mobile tablet sends the metadata directly to the cloud server (or via the base station PC) using, for example, a standard Wifi connection. In some embodiments, the mobile tablet sends the metadata to other mobile tablets using, for example, a standard Wifi connection. When a mobile tablet receives the metadata, it updates its display and metadata database.

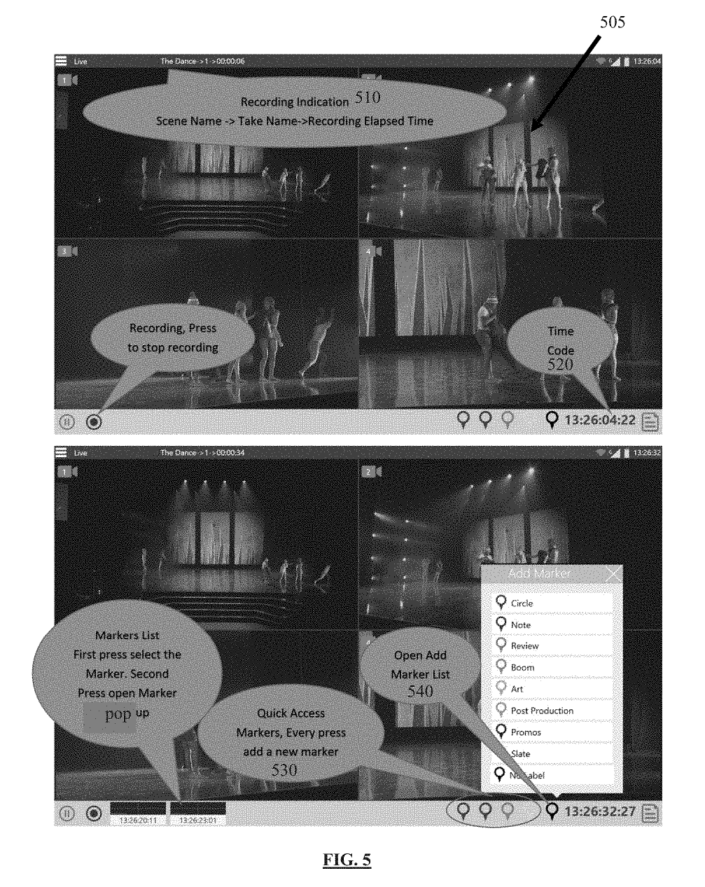

FIG. 5 shows two exemplary screenshots of a SHOTGLASS™ mobile platform display during live recording. The upper screenshot shows the display of live video from four cameras, with upper right quadrant showing the video 505 from camera 2. The recording indication 510 identifies the scene by name and gives the “take” name and recording elapsed time. The time-code 520 uniquely identifies the time point of the displayed video. The lower screenshot illustrates the use of markers. Quick access marker icons 530 allow a user to quickly add a commonly used marker. The “add marker” icon 540 allows the user to add different types of markers by selecting from a pop-up menu.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture.

1. An interactive live video production monitoring and control system comprising:
a plurality of video sources;
an interactive mobile tablet, the interactive mobile tablet comprising an ultra low-latency wireless chip; and
a base station connected to the plurality of video sources, the base station comprising an ultra low-latency wireless chip,
wherein the base station transmits video from the plurality of video sources to the interactive mobile tablet using ultra low-latency wireless communication.

2. The system of claim 1, wherein the interactive mobile tablet plays feeds of single or multiple cameras with imperceptible delay.

3. The system of claim 2, wherein the interactive mobile tablet is adapted to allow a user to view at least one of live and recorded video from one or more cameras.

4. The system of claim 3, wherein the interactive mobile tablet is further adapted to allow the user to annotate segments of video on the interactive mobile tablet.

5. The system of claim 4, wherein the interactive mobile tablet is further adapted to allow the user to generate emails containing the annotations.

6. The system of claim 1, wherein the video latency from the plurality of video sources to the interactive mobile tablet is between 1-7 frames.

7. The system of claim 1, wherein the interactive mobile tablet comprises a zero-latency wireless chip.

8. The system of claim 7, wherein the wireless chip uses Joint-Source-Channel-Coding (JSCC) algorithms.

9. The system of claim 1, wherein the interactive mobile tablet comprises a standard tablet or laptop that further comprises the ultra low-latency wireless chip.

10. The system of claim 1, wherein the mobile interactive tablet is configured to allow a user of the mobile interactive tablet to add video markers in real time.

11. The system of claim 1, wherein the mobile interactive tablet is configured to allow the user to playback video and add markers to the playback video while video is being recorded.

12. The system of claim 1, wherein the mobile interactive tablet is configured to send metadata created on the mobile interactive tablet to other mobile interactive tablets and to the cloud server for access by remote users.

13. The system of claim 1, wherein the mobile interactive tablet comprises memory for storing video locally, and wherein the mobile interactive tablet is configured to allow playback of the video from the memory.

14. A method for interactive live video production monitoring and control comprising:
establishing a low-latency communication link with a base station, the base station connected to a video source;
receiving ultra-low latency video from the video source through the base station in real time;
displaying the video from the video source on a display; and
receiving a user command, wherein the user command allows the user to interact with the video in real time.

15. The method of claim 14, wherein the base station is further connected to an audio source, and wherein the method further comprising:
delivering the audio from the audio source on a speaker.

16. The method of claim 14, wherein the user command is selected from the group consisting of:
change the display of the video sources;
start or end recording of video takes;
add or edit markers;
playback previously recorded video;
add or edit textual and/or graphical video annotations;
import textual documents into the tablet, annotate and edit the textual documents; and
select browsing options to enable viewing of content from the Internet.

17. The method of claim 14, wherein the browsing options comprise side by side with the video content or full screen without imagery.

18. The method of claim 14, wherein the user command generates metadata.

19. The method of claim 18, further comprising transmitting the metadata to the cloud server.

20. The method of claim 19, further comprising transmitting the metadata to connected interactive media tablets.

21. A computer readable hardware medium with executable instructions stored thereon, which when executed by a computer processor, cause said computer to execute a method for interactive live video production monitoring and control comprising, the method comprising:
establishing a low-latency communication link with a base station, the base station connected to a video source;
receiving ultra-low latency video from the video source through the base station in real time;
displaying the video from the video source on a display; and
receiving a user command, wherein the user command allows the user to interact with the video in real time.
